(19) United States
(12) Patent Application Publication
(10) Pub. No.: US 2014/0336866 A1
(43) Pub. Date: Nov. 13, 2014

(54) Method for Determining Input Data of a Driver Assistance Unit

(71) Applicant: Bayerische Motoren Werke Aktiengesellschaft, Muenchen (DE)

(72) Inventors: Horst KLOEDEN, Muenchen (DE); Felix KLANNER, Muenchen (DE)

(73) Assignee: Bayerische Motoren Werke Aktiengesellschaft, Muenchen (DE)

(21) Appl. No.: 14/275,268

(22) Filed: May 12, 2014

(30) Foreign Application Priority Data
May 13, 2013 (DE) 10 2013 208 709.8

(51) Int. Cl. G06K 9/00

(52) U.S. Cl. CPC G06K 9/00791
USPC 701/30.3

(57) ABSTRACT

In a method for determining input data of a driver assistance unit, information data are provided, which were determined as a function of a measurement signal of a first sensor using a predefined first calculation rule. Raw data are provided, which are representative of a measurement signal of the first and/or a second sensor. The plausibility data are determined as a function of the raw data using a predefined second calculation rule. Fusion data, which represent information data that have been checked for plausibility, are determined as a function of the information data and the plausibility data. The fusion data are provided as the input data to the driver assistance unit.

### CROSS REFERENCE TO RELATED APPLICATIONS

This application claims priority under 35 U.S.C. §119 from German Patent Application No. 10 2013 208 709.8, filed May 13, 2013, the entire disclosure of which is herein expressly incorporated by reference.

### BACKGROUND AND SUMMARY OF THE INVENTION

The invention relates to a method for determining input data of a driver assistance unit, to a corresponding computer program, and to a corresponding device for determining input data of a driver assistance unit.

Vehicles today frequently include a plurality of driver assistance systems. A pedestrian protection system is one such system, for example. Such driver assistance systems frequently have an external sensor unit for this purpose, which makes information available to a driver assistance unit in the vehicle. The quality of this information is frequently not known to the driver assistance unit in the vehicle. As a result, faulty assistance may take place, caused by latency, for example.

It is the object of the invention to provide, on the one hand, a method and, on the other hand, a corresponding device, a corresponding computer program and a corresponding computer program product, for determining input data of a driver assistance unit, which each contribute to providing very reliable input data for the driver assistance unit.

The invention is characterized by a method for determining input data of a driver assistance unit. It is also characterized by a corresponding device for determining the input data of the driver assistance unit,

In the method, information data are provided, which were determined as a function of a measurement signal of a first sensor using a predefined first calculation rule. Moreover, raw data are provided, which are representative of a measurement signal of the first or a second sensor. Plausibility data are determined as a function of the raw data using a predefined second calculation rule. Fusion data, which represent information data that have been checked for plausibility, are determined as a function of the information data and the plausibility data. The fusion data are provided as input data to the driver assistance unit.

The information data include, for example, information for the driver assistance unit for a function of the driver assistance unit. For example, the information data include information about a state of movement of a detected pedestrian or information about a command detected by way of voice recognition and/or information about a detected gesture.

The driver assistance unit is part of a driver assistance system, for example, which includes additional sensors and/or display elements, for example, such as a pedestrian protection system and/or further assistance systems.

The second calculation rule differs from the first calculation rule and/or it is applied to raw data that differ from the raw data by way of which the information data were determined. In this way, plausibility data can be determined, which can subsequently be used to check the plausibility of the information data. Delays of the information data, and incorrect information potentially resulting therefrom, can thus be checked, incorrectly determined information can be checked in the information data, and/or latencies in the transmission of the information data can be checked. Very reliable fusion data can thus be determined which are used as input data for a driver assistance unit.

The quality of the information data can be analyzed by checking the information data for plausibility. The degree of the quality level of the first calculation rule can thus be calculated using non-empirical modeling. For example, an essential element of this modeling is the relationship between the raw data and the physical processes of the s ate to be classified, such as that the value range of the acceleration of a pedestrian is directly dependent on the state of movement. The value ranges of different states of movement can overlap.

Since the raw data are provided independently of the information data and of the first calculation rule, the plausibility check can be carried out independently. For example, the plausibility data can be determined in the vehicle and the information data can be determined in a mobile terminal The vehicle manufacturer can thus check and personally validate inputs from mobile terminals by way of a simple option.

According to an advantageous embodiment, the second calculation rule is predefined as compared to the first calculation rule in such a way that the plausibility data have a shorter delay time than the information data.

For example, the delay time in this context correlates with the time that the respective calculation rule requires to detect a transition in the state. The delay time in the case of a pedestrian protection system, for example, is the time that passes between a change in the state of movement of a detected pedestrian and the detection of the change in the state of movement using respective calculation rule.

In this way, delays of the information data, and incorrect information potentially resulting therefrom, can be checked particularly

According to a further advantageous embodiment, the information data have a delay time in the range of seconds.

Due to the long delay time, optionally very robust information data can be determined. However, these information data may be erroneous in the time period between a change in state and the detection of the change in state. This time period can be detected, and optionally resulting incorrect information can be checked, by way of the plausibility data.

According to a further advantageous embodiment, the second calculation rule is designed based on the Dempster-Shafer theory.

For example, only high frequencies are considered for classification in the second calculation rule. The second calculation rule based on the Dempster-Shafer theory is designed as follows, for example: Two discriminators are defined for each class, which define the region of plausibility and the region of confidence, wherein the region of confidence only includes cases that belong to the particular class and the inverse region of plausibility includes no cases that belong to the particular class. The region between the two regions is referred to as unknown with respect to the particular class. In this way, a certain fault classification can be modeled, and thus also accepted, so as to minimize the unknown regions. So as to reduce the unknown region, a cost function can be introduced, for example. The result of the classification can be represented by a mass function, for example. Such a calculation rule, for example, allows plausibility data to be determined with a very short delay time.

According to a further advantageous embodiment, the fusion data are determined using the rule of combination according to Dempster. This allows a very simple combination of two different data, which is to say of the information data and the plausibility data.

According to a further advantageous embodiment, the fusion data are determined using the rule of combination according to Yager.

Since conflicting sources, which is to say the information data and the plausibility data, are penalized under Yager's rule of combination, optionally better or more reliable fusion is possible than using Dempster's rule of combination, in particular if two conflicting sources exist.

According to a further advantageous embodiment, the information data include information about a state of movement of a pedestrian. The raw data are representative of a measurement signal of at least one inertial sensor.

A plausibility check can be very advantageous in particular with a pedestrian assistance system, since in particular here the information data optionally have a very large delay time, which can contribute to an incorrect assessment of danger by the pedestrian assistance system.

According to a further advantageous embodiment, the information data include information about a voice command The raw data are representative of a measurement signal of at least one interior microphone.

With systems having voice control, it may optionally be advantageous to check the voice command, for example so as to check the voice command per se and/or to check whether the voice command sterns from a vehicle driver.

According to a further advantageous embodiment, the information data include information about a recognized gesture. The raw data are representative of a measurement signal of at least one interior camera.

With systems having gesture recognition, it may optionally be advantageous to check the gesture, for example so as to check the gesture per se and/or to check whether the gesture stems from a vehicle driver.

According to a further advantageous embodiment, a system comprises the device for determining the input data of the driver assistance unit. The system additionally comprises a calculation unit, which is designed to determine the information data as a function of the measurement signal of the first sensor using the predefined first calculation rule.

According to a further aspect, the invention is characterized by a computer program for determining input data of a driver assistance unit, wherein the computer program is designed to carry out the method for determining input data of a driver assistance unit, or an advantageous embodiment of the method, on a data processing device.

According to a further aspect, the invention is characterized by a computer program product, which comprises executable program code, wherein the program code carries out the method for determining input data of a driver assistance unit, or an advantageous embodiment of the method, when it is carried out by a data processing device.

The computer program product in particular comprises a medium which can be read by the data processing device and on which the program code is stored.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic block diagram of a system for determining input data of a driver assistance unit;

FIG. 2 is a flow chart for determining the input data of the driver assistance unit; and

FIG. 3 is a graphical diagram with determined fusion data.

### DETAILED DESCRIPTION OF THE DRAWINGS

Elements that are identical in terms of design or function are denoted by identical reference numerals throughout the figures.

FIG. 1 shows a system S. The system S includes a calculation unit BE. For example, the calculation unit BE is implemented in a portable device, such as a smart phone and/or a transponder. The calculation unit BE includes a first sensor SE1, such as an inertial sensor, a camera, a microphone, a yaw rate sensor and/or an acceleration sensor. The calculation unit BE moreover has a first classifier KL1. The calculation unit BE is designed to determine information data ID as a function of a measurement signal of the first sensor SE1 using a predefined first calculation rule, such as by way of the first classifier KL1. For example, the first classifier KL1 is a Bayes classifier by way of which the first calculation rule can be carried out.

The first sensor SE1 and the calculation unit BE can be implemented in one assembly or distributed among two or more assemblies.

The calculation unit BE moreover includes at least one communication interface for transmitting the information data ID. The calculation unit BE can additionally be designed to transmit raw data RD, which are representative of a measurement signal of the first signal SE1, such as by way of the communication interface or by way of a further communication interface.

The system S further includes a control device SV. The control device includes a second classifier KL2. The control device SV has at least one communication interface for receiving the information data ID and a further communication interface for receiving the raw data RD. The control device SV is designed to determine plausibility data PD as a function of the raw data RD using a predefined second calculation rule, such as by way of the second classifier KL2. As an alternative or in addition, the raw data RD can also be provided by a second sensor SE2, which differs from the first sensor SE1 and is optionally implemented in a separate assembly. For example, the second sensor SE2 is a vehicle sensor, such as an interior or exterior camera of a vehicle and/or an interior microphone.

The control device SV is further designed to determine fusion data FD, which represent information data ID that have been checked for plausibility, as a function of the information data ID and the plausibility data PD. It is further designed to provide the fusion data FD as input data ED to a driver assistance unit

The driver assistance unit is part of a driver assistance system, for example, which includes additional sensors and/or display elements, such as a pedestrian protection system.

The control device SV can also be referred to as a device for determining input data of a driver assistance unit.

The control device SV and the calculation unit BE can be implemented in one assembly and/or distributed among two or more assemblies. The control device SV, in combination with the driver assistance unit, can be implemented in one assembly and/or distributed among two or more assemblies.

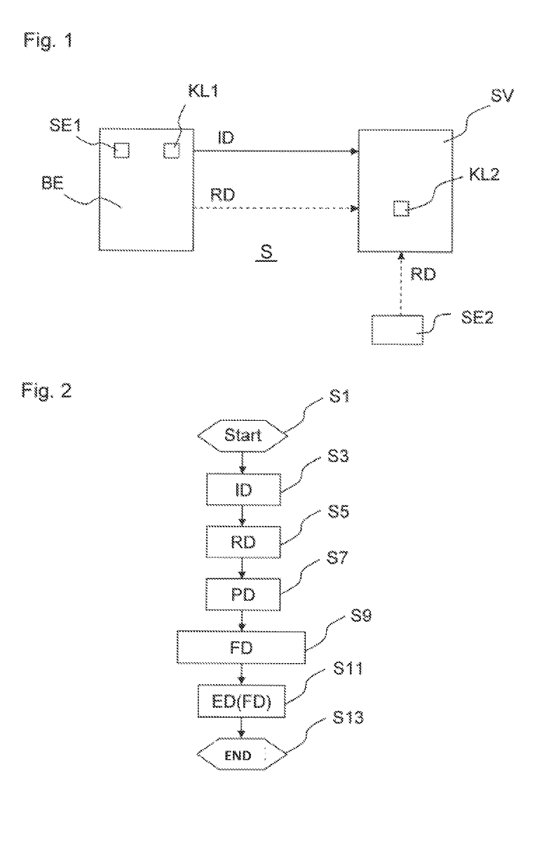

FIG. 2 shows a flow chart of a method, or of a program, such as a computer program, which can be executed in the control device SV for determining the input data ED for the driver assistance unit.

The program is started in a step S1, in which optionally, variables can be initialized.

In step S3, information data ID are provided, which were determined as a function of the measurer rent signal of the first sensor SE1 using a predefined first calculation rule.

For example, the information data ID are determined by the calculation unit BE, for example by way of the first classifier KL1, and transmitted to the control device SV.

In a pedestrian protection system, the information data ID represent a state of movement of a detected pedestrian, for example. In this case, for example, the information data ID are determined by the calculation unit BE by way of the first classifier KL1 as a function of a measurement signal of an inertial sensor, such as an inertial sensor of a smart phone or a mobile transponder of the pedestrian, using the predefined first calculation rule. The first classifier KL1 for this purpose is a Bayes classifier, for example. In this way, the walking pace of the detected pedestrian is evaluated, for example. Such a classification optionally has a high delay time, such as in the seconds range. In this context, the delay time correlates with the time that is required to detect a transition in the state, such as a transition in movement from standing to walking.

As an alternative or in addition, for example, the information data ID can include information about a voice command. For this purpose, a measurement signal of a microphone, for example, such as of a microphone of a smart phone, is evaluated by the calculation unit BE by way of the first classifier KL1 and is subsequently transmitted to the control device SV.

As an alternative or in addition, the information data ID can include information about a recognized gesture. For this purpose, a measurement signal of a camera and/or of an inertial sensor, for example, such as of a camera of a smart phone or of an inertial sensor of a smart phone, is evaluated by the calculation unit BE by way of the first classifier KL1 and is subsequently transmitted to the control device SV.

In step S5, raw data RD are provided, which are representative of a measurement signal of the first sensor SE1 and/or the second sensor SE2.

In the pedestrian protection system, the raw data RD are representative of a measurement signal of the inertial sensor, for example, by way of which the information data ID were determined. As an alternative or in addition, the raw data RD are representative of a measurement signal of a vehicle camera and/or of another suitable sensor.

With an assistance system having voice commands, the raze data RD are representative of a measurement signal of at least one interior microphone of the vehicle, for example. In this way, for example, the length of the voice command can be checked, such as by comparing the signal level of the interior microphone, optionally after subtracting known noise from the radio and/or entertainment systems, to the word length of the voice command. As an alternative or in addition, multiple interior microphones can be used to check whether the voice command stems from a vehicle driver.

With an assistance system having gesture recognition, the raw data RD can represent a measurement signal of at least one interior camera and/or raw data RD of an inertial sensor, for example. It is thus possible, for example, to check whether the gesture stems from a vehicle driver. As an alternative or in addition, it can be checked whether the gesture is plausible, such as by comparing the measurement signal, which comprises images of the interior camera, or a processed measurement signal, which comprises extracted features, such as the optical flow, based on movement intensity, movement location and/or movement direction.

In step S7, plausibility data PD are determined as a function of the raw data RD using a predefined second calculation rule.

The second calculation rule is carried out by way of the second classifier KL2, for example. For example, it takes place by way of a Dempster-Shafer classifier based on the Dempster-Shafer theory. The classification takes place as follows for this purpose.

Two discriminators are defined for each class, which define the region of plausibility and the region of confidence, wherein the region of confidence only includes cases that belong to the particular class and the inverse region of plausibility includes no cases that belong to the particular class. The region between the two regions is referred to as unknown with respect to the particular class, In this way, a certain fault classification can be modeled, and thus also accepted, so as to minimize the unknown regions. So as to reduce the unknown region, a cost function can be introduced, for example. The result of the classification can be represented by a mass function. Such a classification has a very short delay time. It can be employed in the pedestrian protection system, for example.

In step S9, fusion data FD, which represent information data ID that have been checked for plausibility, are determined as a function of the information data ID and the plausibility data PD.

For example, the fusion data FD can be combined by way of Dempster's rule of combination and/or by way of Yager's rule of combination, or by way of another combination method. If two conflicting sources are combined, Dempster's rule of combination may optionally result in errors. This can optionally be prevented with Yager's rule of combination, since conflicting sources are penalized, such as by increasing the weighting of the unknown region or the mass of the unknown region. In particular with danger assistance systems, such as the pedestrian assistance system, a potential misinterpretation can thus be prevented.

In step S11, the fusion data FD are provided as input data ED to the driver assistance unit.

The program is ended in step S13 and can optionally be restarted in step S1.

Steps S3 to S11 can optionally also be processed in parallel or in another sequence. In particular, the plausibility data PD can be determined in step S7 in parallel with and/or independently from the information data ID, for example in that the information data ID are calculated in the calculation unit BE and the plausibility data PD are calculated in the control device SV.

In addition, it is possible by the fusion of two data sources that the control Device SV decides, as a function of the accuracy or as a function of the agreement of the data sources, how to handle the data, for example a decision may be made in the case of two conflicting sources to trust neither of the two sources, particular with danger assistance systems.

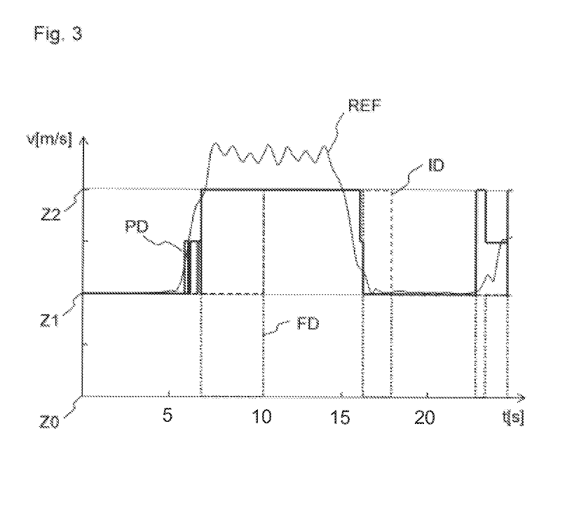

FIG. 3 is a graph showing determined information data ID, plausibility data PD and fusion data FD, by way of example, of a pedestrian movement detection. The reference data REF, which represent processed raw data RD, of the diagram of FIG. 3 show that the pedestrian is moving during the time period between the fifth and fifteenth second. The information data ID, which in this example were determined by way of Bayes classifiers, switch from a standing state Z1 into a walking state Z2 in the eleventh second. The delay time of the information data ID is thus six seconds. The plausibility data PD, which in this example were determined by way of a Dempster-Shafer classifier, switch into the walking state Z2 starting with the seventh second. The delay time of the plausibility data PD is thus two seconds. The fusion data FD switch into the unknown state Z0 for the regions in which the two sources conflict, so that it is at least ensured that a vehicle driver does not think that the pedestrian is standing, when in reality he is walking.

### LIST OF REFERENCE NUMERALS AND SYMBOLS

BE calculation unit
ED input data
FD fusion data
ID information data
KL1 first classifier
KL2 second classifier
PD plausibility data
REF reference data
RD raw data
S system
SE1 first sensor
SE2 second sensor
SV control device

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof

What is claimed is:

1. A method for determining input data of a driver assistance unit, the method comprising the acts of:
providing information data (ID), which information data were determined as a function of a measurement signal of a first sensor using a predefined first calculation rule;
providing raw data (RD), which raw data are representative of a measurement signal of the first sensor or of a second sensor;
determining plausibility data (PD) as a function of the raw data using a predefined second calculation rule;
determining fusion data (FD), which fusion data represent information data that have been checked for plausibility, as a function of the information data and the plausibility data; and
providing the fusion data as the input data (ED) to the driver assistance unit.

2. The method according to claim 1 wherein the second calculation rule is predefined as compared to the first calculation rule such that the plausibility data have a shorter delay time than the information data.

3. The method according to claim 2, wherein the information data have a delay time in a seconds range.

4. The method according to claim 2, wherein the second calculation anile is based on a Dempster-Shafer theory.

5. The method according to claim 1, wherein the fusion data are determined by way of a rule of combination according to Dempster.

6. The method according to claim 1, wherein the fusion data are determined by way of a rule of combination according to Yager.

7. The method according to claim 1, wherein the information data include information about a state of movement of a pedestrian, and further wherein the raw data are representative of a measurement signal of at least one inertial sensor.

8. The method according to claim 1 wherein the information data include information about a voice command, and further wherein the raw data are representative of a measurement signal of at least one interior microphone of a vehicle.

9. The method according to claim 1 wherein the information data include information about a recognized gesture, and further wherein the raw data are representative of a measurement signal of at least one interior camera of a vehicle.

10. An apparatus for determining input data of a driver assistance unit of a motor vehicle, comprising:
a control device configured to receive information data determined as a function of a measurement signal of a first sensor using a predefined first calculation rule and raw data representative of a measurement signal of the first sensor or of a second sensor, wherein
the control device executes processing that:
determine plausibility data (PD) as a function of the raw data using a predefined second calculation rule;
determine fusion data (FD), which fusion data represent information data that have been checked for plausibility, as a function of the information data and the plausibility data; and
provide the fusion data as the input data (ED) to the driver assistance unit.

11. A system for determining input data of a driver assistance unit of a motor vehicle, comprising:
a first sensor;
a calculation unit operatively configured to determine information data as a function of a measurement signal of the first sensor using a predefined first calculation rule;
a control device that receives both the information data and raw data which raw data is representative of the measurement signal of the first sensor or a measurement signal of a second sensor, wherein
the control device executes processing that:
determine plausibility data (PD) as a function of the raw data using a predefined second calculation rule;
determine fusion data (FD), which fusion data represent information data that have been checked for plausibility, as a function of the information data and the plausibility data; and
provide the fusion data as the input data (ED) to the driver assistance unit.

12. A computer program product, comprising:
a computer readable medium having stored thereon executable program code that:
determine information data (ID) as a function of a measurement signal of a first sensor using a predefined first calculation rule;
determine plausibility data (PD) as a function of the raw data using a predefined second calculation rule, the raw data being representative of a measurement signal of the first sensor or of a second sensor;
determine fusion data (FD), which fusion data represent information data that have been checked for plausibility, as a function of the information data and the plausibility data, the fusion data being the input data (ED) to the driver assistance unit.
